(19) United States
(12) Patent Application Publication
(10) Pub. No.: US 2013/0125799 A1
(43) Pub. Date: May 23, 2013

(54) SYSTEMS AND METHODS FOR COMMINUTING AND RECIRCULATING COAL COMBUSTION PRODUCTS

(71) Applicant: Ash Improvement Technology, Inc., Maspeth, NY (US)

(72) Inventors: Wayne Fried, Maspeth, NY (US); Paul J. Sandberg, Beverly, MA (US)

(73) Assignee: ASH IMPROVEMENT TECHNOLOGY, INC., Maspeth, NY (US)

(21) Appl. No.: 13/741,127

(22) Filed: Jan. 14, 2013

Related U.S. Application Data
(63) Continuation-in-part of application No. 12/889,100, filed on Sep. 23, 2010.
(60) Provisional application No. 61/245,594, filed on Sep. 24, 2009.
(60) Provisional application No. 61/586,732, filed on Jan. 13, 2012.

(51) Int. Cl. F23G 5/033; B02C 23/08; F23G 5/08; F23J 1/00; F23J 7/00

(52) U.S. Cl. CPC F23G 5/033; F23J 1/00; F23J 7/00; F23G 5/08; B02C 23/08
USPC 110/342; 241/24.31; 110/347; 110/222; 110/218

(57) ABSTRACT

A method and system for reducing the un-burned carbon content in coal combustion products are disclosed. A coal combustion product is separated into a coarse particle fraction and a fine particle fraction, and the coarse particles are comminuted by milling, grinding or the like. Additives may be added of the coarse particles prior to comminution. The comminuted particles are then co-combusted with coal to burn at least a portion of the un-burned carbon contained in the original coal combustion product.

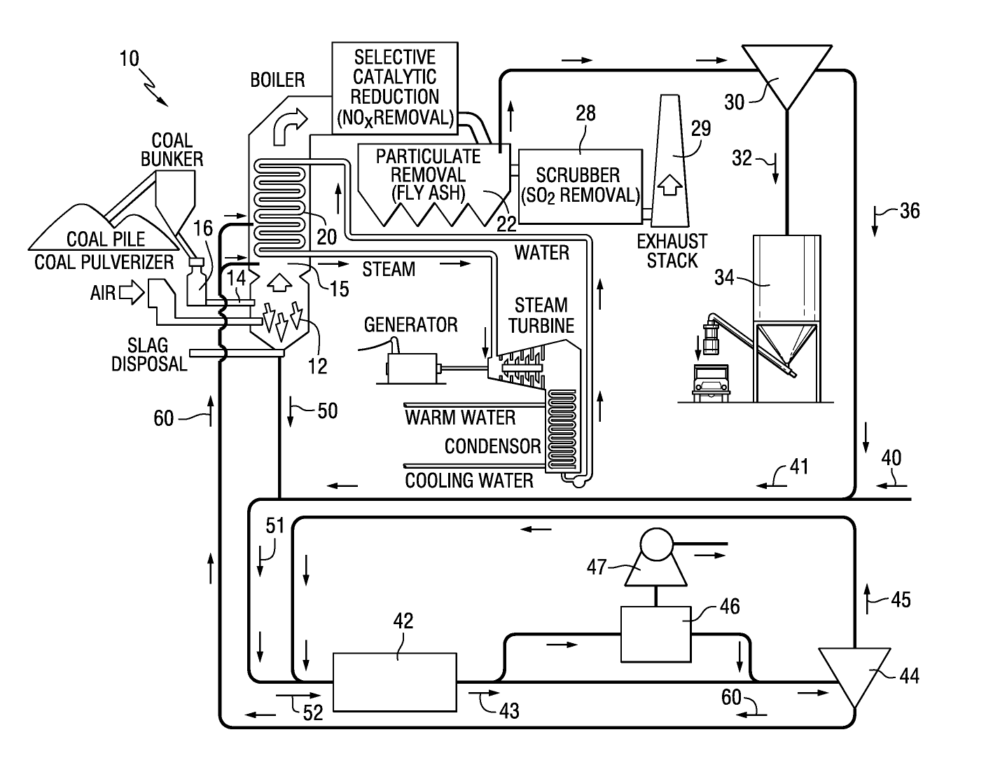

### CROSS-REFERENCE TO RELATED APPLICATION

This application is a continuation-in-part of U.S. patent application Ser. No. 12/889,100 filed Sep. 23, 2010, which claims the benefit of U.S. Provisional Patent Application Ser. No. 61/245,594 filed Sep. 24, 2009. This application also claims the benefit of U.S. Provisional Patent Application Ser. No. 61/586,732 filed Jan. 13, 2012. All of these applications are incorporated herein by reference.

### FIELD OF THE INVENTION

The present invention relates to treatment of coal combustion products, and more particularly relates to systems and methods for comminuting coal combustion products for recirculation into coal-fired burners.

### BACKGROUND INFORMATION

Concrete and other hydraulic mixtures used for construction rely primarily on the manufacture of Portland cement clinker as the main binder controlling the rate of development of mechanical properties. The manufacture of Portland cement clinker is energy intensive and releases large amounts of carbon dioxide into the atmosphere. To reduce the environmental impact of cement and concrete manufacture, supplementary materials with lower carbon dioxide footprint are used to partially replace Portland cement clinker as the binder in hydraulic mixtures.

Large amounts of coal ash and other coal combustion products are generated worldwide from the burning of coal as fuel for electricity generation and other energy intensive applications. A large amount of coal combustion byproducts are disposed of in landfills, at a high economical and environmental cost. Existing methods to beneficiate coal ash so as to make them suitable for other uses, such as in construction, generally do not enable 100 percent usage of coal ashes in beneficial applications. Furthermore, existing treatment methods commonly either use cost ineffective application of chemicals, or require treatment at a separate facility from where the coal combustion takes place, therefore incurring additional transportation costs and capital investments. Currently, most changes made to beneficiate coal combustion products are strictly related to the cleaning or sequestration of harmful chemicals within the coal combustion product.

Unfortunately, the use of coal ash and other coal combustion products in concrete has many drawbacks. For example, addition of fly ash to concrete results in a product with low air entrainment and low early strength development.

Most fly ash produced by coal combustion generally contains a significant percentage of fine, unburned carbon particles, sometimes called char, that reduces the ash's usefulness as a byproduct. Before the fly ash produced by the combustion of coal and/or other solid fuels can be used in most building products applications, it must be processed or treated to reduce residual carbon levels therein. Typically, it is necessary for the ash to be cleaned to as low as 1-2 percent by weight carbon content before it can be used as a cement additive and in other building products applications. If the carbon levels of the fly ash are too high, the ash cannot be used in many of the aforementioned applications. For example, although fly ash production in the United States for 1998 was in excess of 55 million tons, less than 20 million tons of fly ash were used in building product materials and other applications. Consequently, carbon content of the ash is a key factor retarding its wider use in current markets and the expansion of its use to other markets.

In order to lower the residual carbon content of fly ash to appropriate levels, it generally is necessary remove or immobilize excess carbon, for example by the use of a separate combustion system to ignite and combust the carbon. The fly ash particles must be supplied with sufficient temperature, oxygen and residence time in a heated chamber to ignite and burn the carbon within the fly ash particles. Currently, a number of technologies have been explored to try to effect carbon combustion in fly ash to reduce the carbon levels as low as possible. The primary problems that have faced most commercial methods in recent years generally have been the operational complexity of such systems and maintenance issues that have increased the processing costs per ton of processed fly ash, in some cases, to a point where it is not economically feasible to use such methods.

Such current systems and methods for carbon reduction in fly ash include, for example, a system in which the ash is conveyed in basket conveyors and/or on mesh belts through a carbon burn out system that includes a series of combustion chambers. As the ash is conveyed through the combustion chambers it is heated to burn off the carbon therein. Other known ash feed or conveying systems for transport of the ash through combustion chambers have included screw mechanisms, rotary drums and other mechanical transport devices. At the high temperatures typically required for ash processing, however, such mechanisms often have proved difficult to maintain and operate reliably. In addition, such mechanisms typically limit the exposure of the carbon particles to free oxygen by constraining or retaining the ash within baskets or on mesh belts such that combustion is occasioned by, in effect, diffusion through the ash, thereby retarding the effective throughput through the system. Accordingly, carbon residence times within the furnace also must be on the order of upwards of 30 minutes to effect a good burn out of carbon. These factors generally result in a less effective and costlier process.

Another approach to generating carbon combustion in fly ash has utilized bubbling fluid bed technology to affect carbon burn out. In this system, the ash is placed in a bubbling fluid bed supplied with high temperature and oxygen so that the carbon is burned or combusted as it bubbles through the bed. This bubbling fluid bed technology generally requires residence times of the carbon particles within a furnace chamber for up to about 20 minutes or more. The rate of contact of the carbon particles with oxidizing gasses in the bubbling fluid bed also is generally limited to regions in which the bubbles of gas contact solids, such that the rate of contact is related to the effective gas voidage in the bubbling bed, which is typically around 55-60 percent (i.e. around 40-45 percent of solids by volume). These systems have, however, been found to have limited through-put of ash due to effective carbon combustion rates with required carbon particle residence times generally being close to those of other conventional systems.

The present invention has been developed in view of the foregoing and to remedy other deficiencies of the prior art.

### SUMMARY OF THE INVENTION

The present invention provides a method and system for reducing the content of un-burned carbon in coal combustion products. The coal combustion products may be added to cementitious materials to improve the rate of development of mechanical properties in hydraulic mixtures. In accordance with embodiments of the present invention, a coarse, carbon-rich fraction of fly ash is milled or ground with the addition of materials rich in silica, alumina and calcium to form a homogeneous mixture, followed by injection of the mixture into a coal combustion chamber for thermal treatment and incorporation of the mixture with the final coal combustion product. The invention further relates to hydraulic mixtures, e.g., concrete and mortar, that contain coal combustion products that have been modified by the selective separation and cogrinding of coarse fly ash with additions of materials rich in silica, alumina and calcium, optionally with selected colors to form a homogeneous mixture.

An embodiment of the present invention provides a process where coarse fly ash particles with entrapped un-burned carbon are collected and separated from finer fly ash particles by means of a separator, followed by the addition of performance enhancing additives and comminution of the coarse fly ash with the additives to produce a mixture of the additives and the ground fly ash particles comprising released carbon particles. The mixture may then be injected back into a coal combustion chamber to facilitate improved combustion of residual carbon along with further enhancement of the final coal combustion product through the performance additives. The additives may enhance the performance of the resulting coal combustion product through mechanisms such as thermal activation of the additives, dilution of residual carbon, improved combustion of residual carbon, and surface modification of the amorphous phase in fly ash.

An aspect of the present invention is to provide a method of processing a coal combustion product comprising separating the coal combustion product into a coarse particle fraction and a fine particle fraction, comminuting the coarse particle fraction to provide comminuted particles, and combusting the comminuted particles with coal to thereby combust un-burned carbon contained in the comminuted particles.

Another aspect of the present invention is to provide a method of introducing a modified coal combustion product into a coal combustion chamber comprising introducing coal into the combustion chamber, introducing the modified coal combustion product into the combustion chamber, and combusting the coal and the modified coal combustion product, wherein un-burned carbon contained in the modified coal combustion product is combusted.

A further aspect of the present invention is to provide a system for processing a coal combustion product comprising a separator for separating the coal combustion product into a coarse particle fraction and a fine particle fraction, a comminutor for decreasing the average particle size of the coarse particle fraction to provide comminuted particles, and a combustion chamber for combusting the comminuted particles with coal.

Another aspect of the present invention is to provide a feed material for a coal combustion system comprising a comminuted mixture of a coal combustion product, and an additive comprising limestone, concrete, kaolin, recycled ground granulated blast furnace slag, recycled crushed glass, recycled crushed aggregate fines, silica fume, cement kiln dust, lime kiln dust, weathered clinker, clinker, aluminum slag, copper slag, granite kiln dust, rice hulls, rice hull ash, zeolites, limestone quarry dust, red mud, ground mine tailings, oil shale fines, bottom ash, dry stored fly ash, landfilled fly ash, ponded flyash, spodumene lithium aluminum silicate materials, lithium-containing ores and other waste or low-cost materials containing calcium oxide, silicon dioxide and aluminum oxide.

These and other aspects of the present invention will be more apparent from the following description.

### BRIEF DESCRIPTION OF THE DRAWING

The figure is a partially schematic diagram of certain elements of a coal-fired power plant showing a process for comminution of coal combustion products and recirculation of a portion of the comminuted products into the burner of the power plant in accordance with an embodiment of the present invention.

### DETAILED DESCRIPTION

The figure illustrates a coal combustion product processing system 10 in accordance with an embodiment of the present invention. The system may be part of a coal-fired power plant, as more fully described below. Coal combustion products generated from the boiler of the coal-fired power plant are fed to a separator 30, where the coal combustion product is separated into a coarse particle fraction and a fine particle fraction. The fine particle fraction may be stored in a silo 34 or other storage container, or transported for various types of uses. The coarse particle fraction is transferred in the direction of arrow 36 to a comminutor 42 comprising any known type of mill, grinder or the like that is used to reduce the particle size of the coarse particle fraction. The comminuted particles 43 are transferred to another separator 44, where coarse particles 45 are removed and recirculated through the comminutor 42. In the embodiment shown, dust produced in the comminutor 42 may be fed to a dust filter 46 driven by a fan 47 where the fine dust particles are captured and the air in which the dust particles were entrained is exhausted. Comminuted particles of sufficiently small size 60 that pass through the separator 44, are fed to the boiler of the coal-fired power plant. The comminuted particles 60 may be fed into the boiler 15 at any suitable location, such as shown in the figure.

The average particle size of the coarse particle fraction 36 is typically at least 10 percent larger than the average particle size of the comminuted particles 43, for example, 20 or 50 or 100 percent greater. The “average particle size” may be determined by the standard procedure of ASTM B822-10 Standard Test Method for Particle Size Distribution of Metal Powders and Related Compounds by Light Scattering. The coarse particle size fraction 36 may have an average particle size of greater than 50 microns, for example, greater than 100 microns. The comminuted particles 43 may have an average particle size of less than 50 microns, for example, less than 30 or 20 microns.

Additives 40 may be combined with the coarse particle fraction 36 of the coal combustion product to form a mixture 41 that is fed to the comminutor 42. The additives may include limestone, concrete including waste concrete such as recycled Portland cement concrete, kaolin, recycled ground granulated blast furnace slag, recycled crushed glass, recycled crushed aggregate fines, silica fume, cement kiln dust, lime kiln dust, weathered clinker, clinker, aluminum slag, copper slag, granite kiln dust, rice hulls, rice hull ash, zeolites, limestone quarry dust, red mud, fine ground mine tailings, oil shale fines, bottom ash, dry stored fly ash, landfilled fly ash, ponded flyash, spodumene lithium aluminum silicate materials, and lithium-containing ores may also be fed to the comminutor. In the embodiment shown, the additives 40 are combined with the coarse particle fraction 36 before being fed to the comminutor 42. However, the additives 40 and coarse particle fraction 36 may be fed to the comminutor 42 separately, or may be fed to separate comminutors.

As shown in the figure, boiler slag, bed ash and/or bottom ash 50 from the coal-fired power plant may also be fed to the comminutor 42. In the embodiment shown, the ash 50 is combined with the mixture 41 to form a mixture 51 comprising the coarse fraction 36, the additives 40, and the slag or bottom/bed ash 50. This mixture 51 is combined with the coarse particles 45 from the separator to form a feed mixture 52 that enters the comminutor 42.

The figure also schematically illustrates certain elements of a coal-fired power plant. The power plant includes a combustion chamber 15 such as a conventional tangential firing burner configuration. Pulverized coal is introduced into the combustion chamber 15 via at least one coal inlet line 14. A coal hopper feeds into a coal pulverizer 16 which comminutes the coal to the desired particle size for introduction into the combustion chamber 15. The pulverized coal may be mixed with hot air and blown through the inlet(s) 14 into the combustion chamber 15 where the coal is burned. The comminuted particles 60 may be introduced into the combustion chamber 15 via the coal inlet line 14, or separately through one or more additional inlet lines.

Water flows through tube-lined walls of the boiler 20, where it is heated by the combusted coal to form steam that passes to a steam turbine. Combustion products pass from the boiler region to a particulate collection region 22 where the solid combustion products are collected and transferred to the separator 30. Exhaust gas passes through a scrubber 28 and is vented through a stack 29.

Coal fly ash is essentially formed from the combustion gases as they rise from the combustion zone and coalesce above that zone. Typically, when temperatures are in the range of 1,800-2,200° F., these gases form predominantly amorphous hollow spheres. Depending upon the chemistry of the coal being used (using coal as an example), the ash is either an alumina-silicate, from the combustion of bituminous coal, or calcium-alumina-silicate from the combustion of a sub-bituminous coal. While fly ash from sub-bituminous coal may be self-cementing, fly ash from bituminous coal may not be self-cementing.

An embodiment of the invention provides for the selection and addition of raw materials 40 to be added to the coarse fly ash particles 36 with entrapped carbon to increase the carbon removal rate as well as adjusting the color and reactivity of the resulting coal combustion products without any retarding effects on the alite hydration in Portland cement clinker used together with said coal combustion products in a hydraulic mixture.

In certain embodiments, the content of un-burned carbon in the coal combustion product may be measured along with other components affecting the color and reactivity of the resulting product, such as silica, alumina, CaO and other reactive and non-reactive elements are the use of X-ray diffraction methods, including Rietvield analysis, X-ray fluorescence or any other methods to identify said components. Both methods can be used in-line or end-of-line. calorimetric methods are particularly suitable to monitor the reactivity at different stages of the early age development of mechanical properties of hydraulic mixtures comprising Portland cement clinker and coal combustion products. Methods to measure strength (early and late), set time and slump can be derived from any methods described in ASTM standards relative to the measurement of said properties, or measures of conductivity, or ultrasonic methods, or any other method that can measure or infer any of the aforementioned properties. Said methods provide insight into the optimum selection of types, amounts and desired thermal cycle for the different additions to the coal combustion chamber for the purpose of optimizing the value and performance of the resulting product.

The additives 40 may be selected from limestone, waste concrete such as recycled Portland cement concrete, recycled ground granulated blast furnace slag, recycled crushed glass, recycled crushed aggregate fines, silica fume, cement kiln dust, lime kiln dust, weathered clinker, clinker, aluminum slag, copper slag, granite kiln dust, rice hulls, rice hull ash, zeolites, limestone quarry dust, red mud, fine ground mine tailings, oil shale fines, bottom ash, dry stored fly ash, landfilled fly ash, ponded flyash, spodumene lithium aluminum silicate materials, lithium-containing ores and other waste or low-cost materials containing calcium oxide, silicon dioxide and/or aluminum oxide. In accordance with certain embodiments of the present invention, the additives may comprise one or more of the following materials: 7-20 weight percent limestone; 1-5 weight percent ground granulated blast furnace slag; 1-5 weight percent crushed concrete; 0.1-2 weight percent crushed glass; 0.1-5 weight percent kaolin; and 0.01-1 weight percent silica fume. The total amount of the additives may be at least 8 weight percent of the total weight of the comminuted particles, for example, at least 10 weight percent. The additives may be provided in desired particle size ranges and introduced into the combustion chamber in the same region as the coal, or in other regions.

One embodiment of the present invention uses the coal fired boiler of an electric power plant as a chemical processing vessel to produce the combustion products, in addition to its normal function of generating steam for electrical energy. This approach may be taken without reducing the efficiency of the boiler's output while, at the same time, producing a commodity with a controlled specification and a higher commercial value to the construction market. The resulting ash product is designed to have beneficial pozzolanic properties for use in conjunction with Portland cement, or with different chemical modifications also producing a pozzolan that could also be a direct substitution for Portland cement. In both cases, advantages may be both economic and environmental. Landfill needs are reduced, and cost savings result by avoiding transportation and land filling of the ash. In addition, to the extent that the ash replaces Portland cement, it reduces the amount of carbon dioxide and other toxic emissions generated by the manufacture of Portland cement.

In accordance with the present invention, chemical additives like those listed can be added directly to the boiler in such a way that an ash from coal can be enhanced for optimum performance. In certain embodiments, additives such as clays, including kaolin, can be added to the boiler. Such materials may not decompose and recombine with the ash, but rather may be thermally activated and intimately mixed through the highly convective flow patterns inherent in the boiler. The result is a uniform ash/additive blend achieved completely through the boiler combustion process, and requiring no secondary processing. Essentially, as the vapor from the combusted products coalesce when they rise from the high temperature zone, glassy calcia-alumina-silicates will form. Vaporized additives dispersed in the plume will become part of the glassy phase, while those that have not vaporized will act as nuclei for the coalescing vapors. Other additives that do not take part with the glassy phase formation may be intimately mixed with the ash, producing a highly reactive pozzolanic mixture. For example, kaolin introduced in the boiler may not take part in the ash formation, but may transform to metakaolin, an otherwise costly additive.

The intimate blending of the additives directly into a boiler permits the combustion synthesis of the additives together with the coal and relies upon the intimate mixing generated by the convective flow in or near the boiler to produce chemically modified fly ash. This blending may take place in the main combustion zone of the boiler, directly above the main combustion zone in the boiler, or downstream from the boiler. For example, additives such as kaolin, metakaolin, titanium dioxide, silica fume, zeolites, diatomaceous earth, etc. may be added at such downstream locations at other points where the coal combustion products coalesce into amorphous fly-ash particles. In one embodiment, relatively low cost kaolin may be added and converted into metakaolin during the process, thereby resulting in the economical production of metakaolin having desirable strength enhancing properties when added to cement. By virtue of the materials selected as additives to the coal, the resulting ash byproduct can be designed to have a chemical structure that will enable it to act as a cementitious binder together with Portland cement for strength enhancing properties of a cement or a concrete. The particles being injected are, in some cases, much larger than the resulting ash particles, indicating that the intense high-temperature mixing causes particle reduction/attrition both through intense collisions as well as through chemical combustion. For example, the particle size of the combustion product may be such that 90 percent of the particles may be less than 50 microns, typically less than 20 microns, while the particle size of 30 percent or more of the starting additive materials may be greater than 50 or 100 microns.

In addition to using the intense blending nature of the boiler plume for the combustion synthesis of unique ash products, other beneficial additives can be mixed in the high temperature gas flow simply to achieve intimate mixing in a single processing step. Such additions of non-reactive materials can be accomplished without reducing the efficiency of the coal combustion process.

In another embodiment geopolymer cements may be added in the combustion process to reduce pollutants in flue gas. Such geopolymer cements may serve as binding agents for mercury, heavy metals, nitrogen oxides and sulfur oxides, and additional silica.

It is through the injection of these additions that the resultant fly ash formed in the coal combustion process may be modified by the inclusion of the chemical compounds within these additives directly into the coalescing fly ash. In addition, some chemical species added in this manner that do not become chemically bound to the coalescing fly ash are intimately blended with the fly ash through the natural convection in the boiler resulting in a very uniform blending process achieved without the need for secondary, cost intensive, powder blending of the resultant ash product.

In another embodiment, a method is provided for testing the resulting coal combustion ash after addition of other materials and adjusting the combustion parameters and materials to reach target levels of calcium oxide, silicon dioxide and aluminum oxide in the resulting coal combustion ash. Such testing and adjusting may include measuring contents of calcium oxide, silicon dioxide and aluminum oxide and other reactive and non-reactive elements directly. The method also may include measuring properties of concrete made from the resulting coal combustion ash so as to determine early strength, late strength, slump and setting time of the concrete made of the resulting coal combustion ash. The measurements may be coupled to algorithms to rapidly assess the data and make changes to the feed rates in real time.

The testing methods may measure components such as calcium oxide, silicon dioxide and aluminum oxide and other reactive and non-reactive elements using x-ray diffraction (XRD) methods, including Rietvield analysis, x-ray fluorescence (XRF) or any other methods to identify said components. Such methods can be used in-line or end-of-line. Methods to measure strength (early and late), set time and slump can be derived from methods provided in ASTM standards relative to the measurement of such properties, or measures of heat of hydration through calorimeters, or measures of conductivity, or ultrasonic methods, or any other method that can measure or infer any of the aforementioned properties.

In one embodiment, the incorporation of sensors in a boiler that can monitor the in-situ quality/chemistry of an ash product as it is being generated. The sensors can include conventional residual gas analyzers, x-ray fluorescence spectrometers, mass spectrometers, atomic absorption spectrometers, inductively-coupled plasma optical emission spectrometers, Fourier transform infrared spectrometers, and lasers for performing laser induced breakdown spectroscopy, as well as mercury analyzers, NOₓ detectors and SOₓ detectors. The levels of gases, etc. measured by such techniques can be linked to the optimum chemistry of an ash product.

The sensors can provide real-time monitoring feedback to a human controller or an automated analysis system. For example, the sensor(s) may transmit the value of a measured property to a controller which compares the measured value to a reference value and adjusts the flow rate of the strength enhancing material based thereon. The controller may transmit a signal to one or more additive injectors in order to increase or decrease the flow rate of the additive into the combustion zone. The purpose of this feedback system is to link directly to the individual sources of chemical additives and adjust their feed rates to maintain the ash chemistry quality required for optimum concrete performance.

Using gas analysis equipment during the modified coal combustion process, it is also possible to measure the effluent gases generated by the coal combustion process. Typically, these gases include NOₓ, SOₓ, CO₂, and mercury. Through prior analysis of these gas ranges, taken together with the resulting ash reactivity, it is possible to use gas monitoring processes to optimize the addition of the chemical additives. In this way, an optimum reactive ash chemistry can be adjusted in-situ, that is in real time during the coal combustion process, to optimize the chemistry of the resulting coal ash.

The combustion products of the present invention may be added to various types of cement, including Portland cement. For example, the combustion products may comprise greater than 10 weight percent of the cementitious material, typically greater than 25 weight percent. In certain embodiments, the additive comprises 30 to 95 weight percent of the cementitious material.

The present invention provides a method to reduce disposal of coal combustion ashes in landfills by converting them into higher value hydraulic binders, usable as a substitute of cement in quantities in excess of 40% of substitution. Another advantage of the invention is that it provides a cost-effective alternative to other methods to beneficiate coals combustion ashes, by applying the injection of treatment and materials in the combustion boiler, rather than at a separate facility. The method and system enables treatment of the coal combustion ash as a part of the normal process of power generation, thereby reducing the need for transportation to a separate facility, capital outlay for said facility, and also avoiding the application of additional chemicals such as activating agents.

Whereas particular embodiments of this invention have been described above for purposes of illustration, it will be evident to those skilled in the art that numerous variations of the details of the present invention may be made without departing from the invention as defined in the appended claims.

1. A method of processing a coal combustion product comprising:
separating the coal combustion product into a coarse particle fraction and a fine particle fraction;
comminuting the coarse particle fraction to provide comminuted particles; and
combusting the comminuted particles with coal to thereby combust un-burned carbon contained in the comminuted particles.

2. The method of claim 1, further comprising combusting the comminuted particles with an additive.

3. The method of claim 2, wherein the additive is added to the coarse particle fraction before the comminuting step.

4. The method of claim 2, wherein the additive and coarse particles are comminuted by grinding.

5. The method of claim 2, wherein the additive and coarse particles are comminuted by milling.

6. The method of claim 2, wherein the additive is added to the comminuted particles after the comminuting step.

7. The method of claim 1, wherein the comminuted particles have an average particle size less than 50 percent of the average particle size of the coarse particle fraction.

8. The method of claim 1, wherein the coarse particle fraction has an average particle size of greater than 50 microns.

9. The method of claim 8, wherein the comminuted particles have an average particle size of less than 50 microns.

10. The method of claim 1, wherein the coarse particle fraction has a carbon content greater than 3 weight percent, and the combusted comminuted particles have a carbon content less than 2 weight percent.

11. The method of claim 1, wherein the coarse particle fraction has a carbon content greater than 5 weight percent, and the combusted comminuted particles have a carbon content less than 1 weight percent.

12. The method of claim 2, wherein the additive comprises at least one material selected from the group consisting of limestone, concrete, kaolin, recycled ground granulated blast furnace slag, recycled crushed glass, recycled crushed aggregate fines, silica fume, cement kiln dust, lime kiln dust, weathered clinker, clinker, aluminum slag, copper slag, granite kiln dust, rice hulls, rice hull ash, zeolites, limestone quarry dust, red mud, ground mine tailings, oil shale fines, bottom ash, dry stored fly ash, landfilled fly ash, ponded flyash, spodumene lithium aluminum silicate materials, lithium-containing ores and other waste or low-cost materials containing calcium oxide, silicon dioxide and aluminum oxide.

13. The method of claim 2, wherein the additive comprises at least two materials selected from limestone, concrete, kaolin, recycled ground granulated blast furnace slag, recycled crushed glass, recycled crushed aggregate fines, silica fume, cement kiln dust, lime kiln dust, weathered clinker, clinker, aluminum slag, copper slag, granite kiln dust, rice hulls, rice hull ash, zeolites, limestone quarry dust, red mud, ground mine tailings, oil shale fines, bottom ash, dry stored fly ash, landfilled fly ash, ponded flyash, spodumene lithium aluminum silicate materials, lithium-containing ores and other waste or low-cost materials containing calcium oxide, silicon dioxide and aluminum oxide.

14. The method of claim 2, wherein the additive comprises limestone, granulated blast furnace slag, kaolin, crushed glass, crushed concrete, aluminum slagponded fly ash and combinations thereof.

15. The method of claim 2, wherein the additive comprises at least 8 weight percent of the total weight of the comminuted particles.

16. The method of claim 15, wherein the additive comprises at least 10 weight percent.

17. The method of claim 1, further comprising mixing the coarse particle fraction with boiler slag, bed ash or bottom ash before the comminuting step.

18. The method of claim 17, wherein the coal combustion product, and the boiler slag, bed ash or bottom ash, are generated from the same combustion chamber.

19. The method of claim 1, wherein the comminuted particles are combusted in the same combustion chamber that the coal combustion product is generated from.

20. A method of introducing a modified coal combustion product into a coal combustion chamber comprising:
introducing coal into the combustion chamber;
introducing the modified coal combustion product into the combustion chamber; and
combusting the coal and the modified coal combustion product, wherein un-burned carbon contained in the modified coal combustion product is combusted.

21. The method of claim 20, wherein the modified coal combustion product is produced by comminuting a coal combustion product.

22. The method of claim 21, further comprising separating a fine particle fraction from the coal combustion product before the comminuting step.

23. The method of claim 20, wherein the modified coal combustion product includes an additive comprising limestone, concrete, kaolin, recycled ground granulated blast furnace slag, recycled crushed glass, recycled crushed aggregate fines, silica fume, cement kiln dust, lime kiln dust, weathered clinker, clinker, aluminum slag, copper slag, granite kiln dust, rice hull, rice hull ash, zeolites, limestone quarry dust, red mud, ground mine tailings, oil shale fines, bottom ash, dry stored fly ash, landfilled fly ash, ponded flyash, spodumene lithium aluminum silicate materials, lithium-containing ores and other waste or low-cost materials containing calcium oxide, silicon dioxide and aluminum oxide.

24. A system for processing a coal combustion product comprising:
a separator for separating the coal combustion product into a coarse particle fraction and a fine particle fraction;
a comminutor for decreasing the average particle size of the coarse particle fraction to provide comminuted particles; and
a combustion chamber for combusting the comminuted particles with coal.

25. The system of claim 24, further comprising means for adding an additive to the coarse particle fraction.

26. A feed material for a coal combustion system comprising a comminuted mixture of:
a coal combustion product; and
an additive comprising limestone, concrete, kaolin, recycled ground granulated blast furnace slag, recycled crushed glass, recycled crushed aggregate fines, silica fume, cement kiln dust, lime kiln dust, weathered clinker, clinker, aluminum slag, copper slag, granite kiln dust, rice hulls, rice hull ash, zeolites, limestone quarry dust, red mud, ground mine tailings, oil shale fines, bottom ash, dry stored fly ash, landfilled fly ash, ponded flyash, spodumene lithium aluminum silicate materials, lithium-containing ores and other waste or low-cost materials containing calcium oxide, silicon dioxide and aluminum oxide.
